(19) United States
(12) Patent Application Publication
(10) Pub. No.: US 2005/0097093 A1
(43) Pub. Date: May 5, 2005

(54) System and method for evaluating a collection of patents

(76) Inventor: Gavin Clarkson, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/977,591

(22) Filed: Oct. 29, 2004

Related U.S. Application Data
(60) Provisional application No. 60/515,814, filed on Oct. 30, 2003.

(51) Int. Cl. G06F 17/30

(52) U.S. Cl. 707/3; 715/512

(57) ABSTRACT

System and method evaluate a collection of patents. A set of citations between the patent in the collection is established and a density associated with the collection of patents as a function of the set of citations is determined.

The present application claims priority to U.S. Provisional Patent Application Ser. No. 60/515,814, filed Oct. 30, 2003, which is hereby incorporated by referenced.

### FIELD OF THE INVENTION

The present application relates generally to patents and more particularly to a method and system for establishing a density of a collection of patents.

### BACKGROUND OF THE INVENTION

When organizations in technology industries attempt to advance their innovative activities, they almost always must be cognizant of the intellectual property rights of others. When further innovation is thwarted due to existing patents, however, the situation can be described as a patent thicket. Although the term “patent thicket” seems to have originated in litigation in the 1970s regarding Xerox's dominance of a portion of the photocopier industry, economist Carl Shapiro re-introduced the term in academic discourse in 2000. Shapiro defines a patent thicket more broadly to encompass the intellectual property portfolios of several companies that form “a dense web of overlapping intellectual property rights that a company must hack its way through in order to actually commercialize new technology,” and he points out that “with cumulative innovation and multiple blocking patents, . . . patent rights can have the perverse effect of stifling, not encouraging, innovation”.

Despite all that has been written about patent thickets, an objective methodology for verifying the existence of a patent thicket has never been developed. Throughout the last 150 years, however, organizations have stumbled into a number of patent thickets and have occasionally responded by constructing patent pools, which may be defined as organizational structures where multiple firms collectively aggregate patent rights into a package for licensing, either among themselves or to any potential licensees irrespective of membership in the pool. Such collaboration among technologically competing firms, however, has often encountered difficulty from an antitrust standpoint, even if the formation of the pool is pro-competitive.

While the existence of a patent thicket is a necessary but insufficient condition for demonstrating that a given collection of patents is a pro-competitive solution to a particular patent thicket problem, the antitrust regime has never had an objective method of verifying the existence of a patent thicket in a given section of patent space.

The lack of a tool or method to facilitate the determination of whether a collection of patents constitutes a patent thicket is most evident when evaluating a patent pool as a possible solution to a given patent thicket. While the antitrust and intellectual property regimes were frequently in tension for most of the 20th century, with patent pooling often facing rather aggressive antitrust enforcement even in situations where the pool was pro-competitive, recent developments indicate that these two areas of law can be aligned so as to foster rather than stifle innovation. The 1995 Guidelines for the Licensing of Intellectual Property (“IP Guidelines”), jointly issued by the U.S. Department of Justice (“DOJ”) and the Federal Trade Commission (“FTC”), formally acknowledged that collective ownership structures for intellectual assets, including patent pools, could potentially be pro-competitive solutions to the patent thicket problem.

While the IP Guidelines represent a welcome change in attitude by the antitrust enforcement regime, notably absent are any specific methodologies for examining a patent pool in the antitrust context.

Recent history also demonstrates the problematic nature of the antitrust regime's inability to objectively verify the existence of a patent thicket. On Jun. 26, 1997, the DOJ issued a Business Review letter indicating that a patent pool based on MPEG-2, a technology standard for compactly representing digital video and audio signals for consumer distribution, was deemed not to be in violation of the antitrust laws of the United States. Less than a year later, however, on Mar. 24, 1998, the FTC filed a complaint against a patent pool formed around photorefractive keratectomy (“PRK”), or laser eye surgery technology, and ultimately forced the pool to dissolve. One of the FTC litigators would later write that the pool in question might actually have been a pro-competitive solution to a patent thicket.

As discussed above, the actual existence of a patent thicket is a necessary (but insufficient) condition for a pro-competitive combination of patents. However, in the prior art, such an analysis must be performed using a brute force method including search for relevant patents and analyzing the claims thereof. The prior art does not include a clear method for determining the existence of a patent thicket.

The present invention is aimed at one or more of the problems set forth above.

### SUMMARY OF THE INVENTION

In a first aspect of the present invention, a method for evaluating a first collection of patents is provided. The method includes the steps of establishing a set of citations between the patents in the first collection and establishing a density associated with the first collection of patents as a function of the set of citations.

In a second aspect of the present invention, a method for finding potential patent thickets in a collection of patents is provided. The method includes the steps of establishing a set of citations between the patents in the collection of patents, establishing a density associated with the collection of patents, establishing a subset of patents from the collection of patents, establishing a density associated with the subset of patents, comparing the density associated with the collection of patent with the density associated with the subset of patents, and classifying the subset of patents as a patent thicket if the density associated with the subset of patents is greater than the density associated with the collection of patents.

In a third aspect of the present invention, a system for evaluating a first collection of patents is provided. The system includes a database and a computer. The database contains data relating to a plurality of patents. The computer accesses the database, establishes a set of citations between the patents in the first collection, and establishes a density associated with the first collection of patents as a function of the set of citations.

In a fourth aspect of the present invention, a system for finding potential patent thickets in a collection of patents is provided. The system includes a database and a computer. The database contains data relating to a plurality of patents. The computer accesses the database and establishes a set of citations between the patents in the collection of patents, establishes a density associated with the collection of patents, establishes a subset of patents from the collection of patents, establishes a density associated with the subset of patents, compares the density associated with the collection of patent with the density associated with the subset of patents, and classifies the subset of patents as a patent thicket if the density associated with the subset of patents is greater than the density associated with the collection of patents.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is block diagram of a system for evaluating a collection of patents, according to an embodiment of the present invention;

FIG. 2 is a flow diagram of a method for evaluating a collection of patents, according to an embodiment of the present invention; and

FIG. 3 is a flow diagram of a second method for evaluating a collection of patents according an embodiment of the present invention.

### DETAILED DESCRIPTION OF INVENTION

With reference to the drawings and in operation, the present invention provides a system 10 and methods 20, 30 for evaluating a collection of patents.

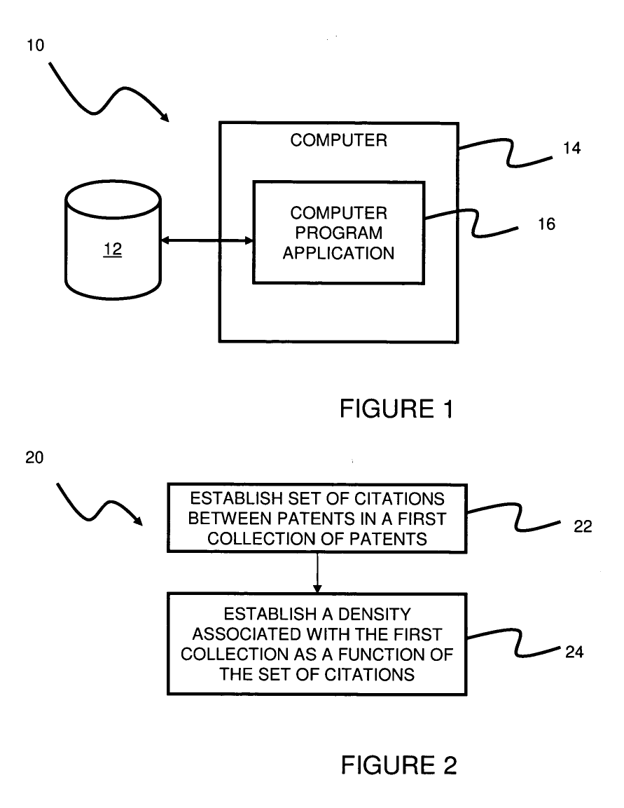

With specific reference to FIG. 1, the system or computer system 10 will now be described, according to an embodiment of the present invention.

The system 10 includes a database 12 for storing data related to a collection of patents. The information may include, but is not limited to, the title, inventors, filing date, issued date, patent number, and the patents, published patent applications, and other documents which were cited against the patent. The system 10 includes a computer 14 which may be a stand-alone computer or may be connected to one or more computers through a network. The database 12 may be stored on the computer 14 or may be stored on a separate computer located remotely. The computer 14 is adapted to run a computer program application 16 in a conventional manner. In one embodiment, the computer 14 is operable by a user through a graphical user interface or GUI (not shown).

In one aspect, the present invention may be utilized to establish a density of a collection of patents. The established density may be used to confirm or determine if the collection of patents is sufficiently dense enough to constitute a patent thicket.

In another aspect, the present invention may be utilized to establish subset of patents from a larger collection of patents and to establish a density of the subset of patents. The established density may be used to determine if the subset of patents constitutes a patent thicket. This process may be repeated until the established subset if chosen such that it is a patent thicket.

With specific reference to FIG. 2, in one aspect of the present invention, the method 20 may be used to evaluate a first collection of patents. In a first step 22, a set of citations between the patents in the first collection is established. In a second step 24, a density associated with the first collection of patents as a function of the set of citations is established.

In one embodiment, the first collection of patents may be compared with a second collection of patents in order to determine if the first collection of patents may be classified as a patent thicket.

In one aspect of the invention, the second collection of patents are related to the first collection of patents.

For example the second collection of patents may be the “surrounding patent universe”. In other words, the second collection of patents may be the patents contained in a given set of one or more technology classes. The first collection of patents may be a subset of the second collection of patents.

Alternatively, the second collection of patents may be a relevant “near universe of patents”. For example, the first and second collection of patents may be the patents in related technology classes.

After the second collection of patents has been established, citations between the patents in the second collection may be established, based on the data contained in the database. Based on the established citations, a density of the second collection of patents may be established.

The density of the first collection of patents may then be compared with the density of the second collection of patents. The relative densities of each collection of patents may be used as an indication of whether the first collection of patents may be treated as a patent thicket.

In one embodiment, if the established density of the first collection is greater than then the density of the second collection, then the first collection may be identified as a patent thicket.

In another embodiment, the first collection may be identified as a patent thicket if its density is greater than the density of the second collection by a predetermined value.

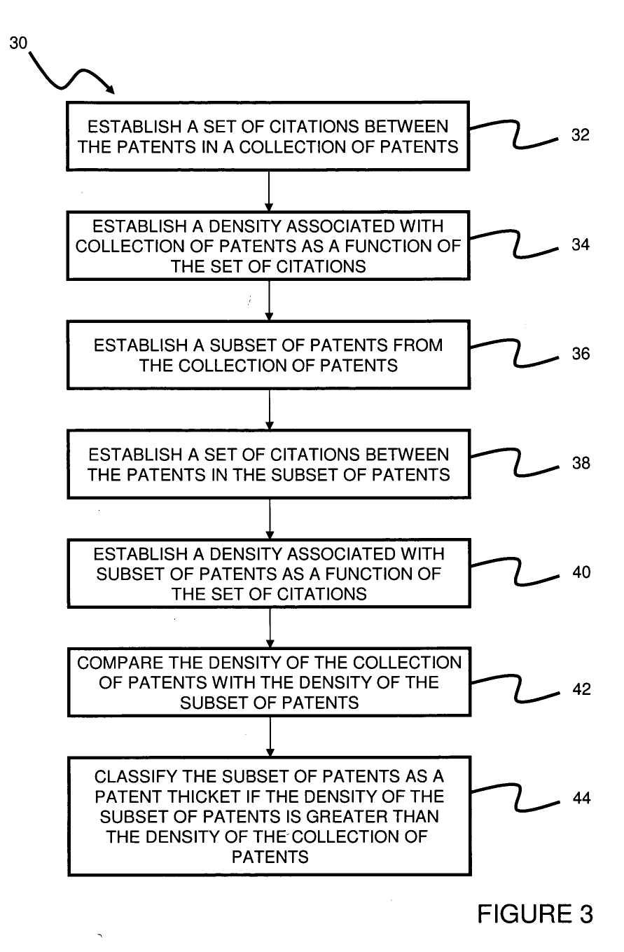

With reference to FIG. 3, the method 30 may be used to find a potential patent thicket in a collection of patents. In one aspect, the method 30 may be used iteratively. In other, different subsets of patents from the larger collection of patents may be tested to determine if their density is greater that the density of the patents in the larger collection. The subsets may be randomly or methodically chosen or may be established using a set of pre-determined criteria. Using the method 30, one or more potential patent thickets may be determined.

In a first step 32, a set of citations between the patents in the collection of patents is established. In a second step 34, a density associated with the collection of patents is established as a function of the set of citations between the patent in the collection of patents. In a third step 36, a subset of patents from the collection of patents is established. In a fourth step 38, a set of citations between the patents in the subset of patents is established. And in a fifth step 40, a density associated with the subset of patents as a function of the set of citations between the patents in the subset of patents is established.

In a sixth step 42, the density associated with the collection of patent is compared with the density associated with the subset of patents. And in a seventh step 44, the subset of patents may be classified as a patent thicket if the density associated with the subset of patents is greater than the density associated with the collection of patents. Alternatively, the subset of patents may be classified as a patent thicket if the difference between the density associated with the subset collection is greater than a predetermined value.

As discussed above, in the present invention the determination of whether a given collection or subset of patents is a patent thicket is based on a measure of patent density.

The standard network density equation for a directed network with g nodes is:

$$Δ = \frac{{\sum }_{i = 1}^{g} {\sum }_{j = 1}^{g} {x}_{ij}}{g ( g - 1 )} \qquad EQN . ( 1 )$$

EQN. 1 essentially counts up the total number of ties in a network and divides that total by the number of possible ties, where xᵢⱼ is the value of the tie from node i to node j.

A core assumption of the standard density calculation is that each node in the network has a possible tie to each of the other nodes, an assumption which does not hold true for patents. In order to derive a density calculation for patent networks, it is necessary to deconstruct the standard calculation and then rebuild a patent-capable density calculation.

For a g-node network of patents, each node (or patent) n can cite g-1 other nodes. Thus the total possible number of nodes is g(g-1), which is the denominator in the standard calculation. Individually, each node (or patent) n has a local network density Δₙ, which equals the number of ties to and from node n divided by the total possible ties for that node, g-1.

$${Δ}_{n} = {\sum }_{j = 1}^{g} \frac{{x}_{nj}}{g - 1} \qquad EQN . ( 2 )$$

Summing the local densities for all g nodes and dividing by g results in the standard density equation (1) above. Note that each local density has the same denominator g-1, which is only true if each node n can tie to each of the g-1 other nodes in the network.

That assumption does not hold true for patents, as any given patent can only cite patents that were issued previously. Subsequent patents cannot be cited by a prior patent, and thus the standard density equation cannot accurately correspond to patent network density.

Assuming a patent network with g patents, each node n can cite n-1 other patents. As one traverses the patent network chronologically, younger patents have more and more possible citations that they can make. The oldest patent in the network, however, will have zero possible citations to make, which would result in an undefined local density for that patent. The local density for the oldest patent is thus discarded to avoid an undefined result. Local patent density Δₙₚ for each subsequent patent n is derived by totaling up the citations actually made, or outdegrees, and dividing by the possible citations that could be made by that patent.

$${Δ}_{np} = {\sum }_{j = 1}^{g} \frac{{x}_{nj}}{n - 1} \qquad EQN . ( 3 )$$

The average density for a patent network based on citations made is then derived by summing the remaining patent densities and dividing by g-1. Thus, patent network density Δₚ₋ₒᵤₜ is

$${Δ}_{p - out} = \frac{{\sum }_{n = 2}^{g} {\sum }_{j = 1}^{g} \frac{{x}_{nj}}{n - 1}}{g - 1} \qquad EQN . ( 4 )$$

While EQN. (4) is a density measure based on citations made, or outdegrees, it may be useful in certain circumstances to calculate patent network density using citations received, or indegrees. Rewriting EQN. (4) to use citations received requires a few modifications. Instead of discarding the local density of the oldest patent, the local indegree density for the youngest patent is discarded, as no other patents in the network can cite to it.

$${Δ}_{p - in} = \frac{{\sum }_{j = 1}^{g} {\sum }_{n = 2}^{g} \frac{{x}_{nj}}{n - 1}}{g - 1} \qquad EQN . ( 5 )$$

Intra-network citations made by earlier patents are given more weight in EQN. (4) because the denominator for each local density is the number of possible citations that can be made. EQN. (5) behaves similarly, although citations made to more recent patents are given more weight. While treating such earlier or later citations as more important might seem appropriate for analyzing patent thickets and patent pools, a weighted density measure would likely be somewhat more robust.

Weighting each local density by the possible number of citations results in a weighted average patent network density Δₚ.

$${Δ}_{p} = \frac{{\sum }_{n = 1}^{g} {\sum }_{j = 1}^{g} {x}_{nj}}{g ( g - 1 ) / 2} \qquad EQN . ( 6 )$$

This formulation of patent network density has a number of advantages. EQN. (6) still produces the proper result for a complete network and is simpler to calculate than either EQN. (4) or (5). Additionally, as with EQN. (1), calculating density based on citations made results in the same density for citations received. Whereas the result of EQNs. (4) and (5) will vary depending on which individual patents cite other patents like EQN. (1), EQN. (6) is not affected by variations in citation placement so long as the total number of citations remains the same.

In one embodiment, the value associated with the citation from patent n to patent j has a value of 1 if patent n cites patent j and a value of 0 if patent n does not cite patent j.

In another embodiment, the value associated with the citation from patent n to patent j is an indication of the strength of a relationship between patent n and patent j.

In order to validate the measure of patent network density Δₚ, it would be useful to examine an area of the intellectual property space that is likely to have variation in densities. As discussed earlier, a logical starting point is Shapiro's suggestion that patent pools form where patent thickets already exist. If a patent pool is coincident with a patent thicket, then the density of the pool should be higher than the surrounding patent universe. As an alternative to calculating the density for the complete universe of patents in a given set of technology classes, a relevant near universe may be able to be constructed which should still provide a sufficient density contrast to identify a patent thicket. Although there has been relatively little empirical examination of network density both of these propositions can be stated as testable hypotheses:
H1: Patent network density Δₚ will be higher for a patent thicket than for the surrounding patent universe.
H2: Patent network density Δₚ will be higher for a patent thicket than for a relevant near universe.

This exercise is analogous to looking at a map of the United States that only displays roads and highways (i.e. no cities) and trying to identify where the cities are located based on the relative density of the roads.

1. A method for evaluating a first collection of patents, comprising the steps of:
establishing a set of citations between the patents in the first collection;
establishing a density associated with the first collection of patents as a function of the set of citations.

2. A method, as set forth in claim 1, wherein the density associated with the first collection of patents, Δₚ is established using the equation:
$${Δ}_{p} = \frac{{\sum }_{n = 1}^{g} {\sum }_{j = 1}^{g} {x}_{nj}}{g ( g - 1 ) / 2}$$
where, g is the number of patents in the first collection, and xₙⱼ is a value associated with the citation from patent n to patent j.

3. A method, as set forth in claim 2, wherein the value associated with the citation from patent n to patent j has a value of 1 if patent n cites patent j and a value of 0 if patent n does not cite patent j.

4. A method, as set forth in claim 2, wherein the value associated with the citation from patent n to patent j is an indication of the strength of a relationship between patent n and patent j.

5. A method, as set forth in claim 1, including the steps of:
establishing a second collection of patents, the second collection of patents being related to the first collection of patents;
establishing a set of citations between the patents in the second collection;
determining a density associated with the second collection of patents as a function of the set of citations between the patents in the second collection; and,
comparing the density associated with the first collection with the density associated with the second collection.

6. A method, as set forth in claim 5, including the step of classifying the first collection of patents as a patent thicket if the density associated with the first collection is greater than the density associated with the second collection.

7. A method, as set forth in claim 6, wherein the first collection of patent is classified as a patent thicket if the difference between the density associated with the first collection is greater than a predetermined value.

8. A method for finding potential patent thickets in a collection of patents, comprising:
(a) establishing a set of citations between the patents in the collection of patents;
(b) establishing a density associated with the collection of patents as a function of the set of citations between the patent in the collection of patents;
(c) establishing a subset of patents from the collection of patents;
(d) establishing a set of citations between the patents in the subset of patents;
(e) establishing a density associated with the subset of patents as a function of the set of citations between the patents in the subset of patents;
(f) comparing the density associated with the collection of patent with the density associated with the subset of patents; and,
(g) classifying the subset of patents as a patent thicket if the density associated with the subset of patents is greater than the density associated with the collection of patents.

9. A method, as set forth in claim 8, wherein the subset of patents is classified as a patent thicket if the difference between the density associated with the subset collection is greater than a predetermined value.

10. A method, as set forth in claim 8, wherein the density associated with the collection of patents and the subset of patents is established using the equation:
$$\frac{{\sum }_{n = 1}^{g} {\sum }_{j = 1}^{g} {x}_{nj}}{g ( g - 1 ) / 2}$$
where, g is the number of patents in the collection or subset of patents, and xₙⱼ is a value associated with the citation from patent n to patent j.

11. A method, as set forth in claim 10, wherein the value associated with the citation from patent n to patent j has a value of 1 if patent n cites patent j and a value of 0 if patent n does not cite patent j.

12. A method, as set forth in claim 10, wherein the value associated with the citation from patent n to patent j is an indication of the strength of a relationship between patent n and patent j.

13. A method, as set forth in claim 8, including the step of repeating steps (c) through (g).

14. A system for evaluating a first collection of patents, comprising:
a database containing data relating to a plurality of patents;
a computer for accessing the database and for establishing a set of citations between the patents in the first collection and establishing a density associated with the first collection of patents as a function of the set of citations.

15. A system, as set forth in claim 14, wherein computer established the density associated with the first collection of patents, Δₚ using the equation:
$${Δ}_{p} = \frac{{\sum }_{n = 1}^{g} {\sum }_{j = 1}^{g} {x}_{nj}}{g ( g - 1 ) / 2}$$
where, g is the number of patents in the first collection, and xₙⱼ is a value associated with the citation from patent n to patent j.

16. A system, as set forth in claim 15, wherein the value associated with the citation from patent n to patent j has a value of 1 if patent n cites patent j and a value of 0 if patent n does not cite patent j.

17. A system, as set forth in claim 15, wherein the value associated with the citation from patent n to patent j is an indication of the strength of a relationship between patent n and patent j.

18. A system, as set forth in claim 14, the computer for establishing a second collection of patents, the second collection of patents being related to the first collection of patents, establishing a set of citations between the patents in the second collection, determining a density associated with the second collection of patents as a function of the set of citations between the patents in the second collection, and comparing the density associated with the first collection with the density associated with the second collection.

19. A system, as set forth in claim 18, including the step of classifying the first collection of patents as a patent thicket if the density associated with the first collection is greater than the density associated with the second collection.

20. A system, as set forth in claim 19, wherein the first collection of patent is classified as a patent thicket if the difference between the density associated with the first collection is greater than a predetermined value.

21. A system for finding potential patent thickets in a collection of patents, comprising:
a database containing data relating to a plurality of patents;
a computer for accessing the database and for establishing a set of citations between the patents in the collection of patents, establishing a density associated with the collection of patents as a function of the set of citations between the patents in the collection of patents, establishing a subset of patents from the collection of patents, establishing a set of citations between the patents in the subset of patents, establishing a density associated with the subset of patents, comparing the density associated with the collection of patent with the density associated with the subset of patents, and classifying the subset of patents as a patent thicket if the density associated with the subset of patents is greater than the density associated with the collection of patents.

22. A system, as set forth in claim 21, the computer for classifying subset of patents classified as a patent thicket if the difference between the density associated with the subset of patents and the collection of patents is greater than a predetermined value.

23. A system, as set forth in claim 21, wherein the density associated with the collection of patents and the subset of patents is established using the equation:
$$\frac{{\sum }_{n = 1}^{g} {\sum }_{j = 1}^{g} {x}_{nj}}{g ( g - 1 ) / 2}$$
where, g is the number of patents in the collection or subset of patents, and xₙⱼ is a value associated with the citation from patent n to patent j.

24. A system, as set forth in claim 23, wherein the value associated with the citation from patent n to patent j has a value of 1 if patent n cites patent j and a value of 0 if patent n does not cite patent j.

25. A system, as set forth in claim 23, wherein the value associated with the citation from patent n to patent j is an indication of the strength of a relationship between patent n and patent j.
